(19) United States
(12) Patent Application Publication
(10) Pub. No.: US 2007/0175094 A1
(43) Pub. Date: Aug. 2, 2007

(54) Integrated autothermal reformer recuperator

(76) Inventors: Michael J. Reinke, Franklin, WI (US); Jeroen Valensa, Muskego, WI (US); Mark G. Voss, Franksville, WI (US); Dennis C. Granetzke, Racine, WI (US)

Correspondence Address: MICHAEL BEST & FRIEDRICH, LLP, 100 E WISCONSIN AVENUE, Suite 3300, MILWAUKEE, WI, 53202, US

(21) Appl. No.: 11/342,751

(22) Filed: Jan. 30, 2006

(51) Int. Cl. B01J 8/00

(52) U.S. Cl. 48/127.9

(57) ABSTRACT

An integrated autothermal reformer/recuperator unit (10) is provided for reforming a feed gas flow to produce a reformate flow. The unit (10) includes a cylindrical housing (18) having a feed gas inlet (26) and a reformate flow outlet (32) located adjacent a first end (20) of the cylindrical housing (18). An autothermal reformer catalyst structure (12) is located in the housing and spaced from the first end, and a recuperator heat exchanger (16) is located in the housing (18) between the first end (20) and the catalyst structure (12).

### FIELD OF THE INVENTION

This invention relates to fuel reformers, and in more particular applications to fuel reformers that utilize autothermal reforming and a recuperator.

### BACKGROUND OF THE INVENTION

It is known in fuel reformation to utilize an autothermal reformer (“ATR”) having a traditional stack plate design and to provide a recuperator as a separate discrete component. While such designs may work for their intended purpose, there is always room for improvement. For example, there is always room to reduce cost, and/or increase compactness, and/or increase life, etc.

### SUMMARY OF THE INVENTION

In accordance with one feature of the invention, an integrated autothermal reformer/recuperator unit is provided for use in reforming a feed gas flow to produce a reformate flow.

According to one feature, the integrated unit includes a housing, a cylindrical wall located in the housing; an autothermal reformer catalyst structure located within the cylindrical wall; and a recuperator heat exchanger located in the housing. The housing includes a feed gas inlet and a reformate flow outlet. The cylindrical wall has an inlet end to receive the feed gas flow into an interior volume surrounded by the cylindrical wall, and is positioned relative to the feed gas inlet and outlet to direct the feed gas flow from the feed gas inlet to the inlet end and to direct the reformate flow from the interior volume to the reformate flow outlet. The autothermal reformer catalyst structure is contained in the interior volume to receive the feed gas flow and deliver a reformate flow to the interior volume. The recuperator heat exchanger includes a feed gas flow path in heat exchange relation with a reformate flow path. The feed gas flow path is defined between the housing and the cylindrical wall at a location upstream from the inlet end with respect to the feed gas flow, and the reformate flow path is located within the interior volume downstream from the catalyst structure with respect to the reformate flow.

In one feature, the reformate flow path is defined between the cylindrical wall and a second cylindrical wall contained within the interior volume.

According to one feature, the integrated unit further includes a baffle located between the catalyst structure and the reformate flow path to direct the reformate flow into the reformate flow path.

As one feature, the catalyst structure includes a catalyst monolith.

According to one feature, the integrated unit further includes an end baffle connected to the cylindrical wall at an end of the cylindrical wall opposite from the inlet end to direct the reformate flow from the reformate flow path to the reformate flow outlet.

In accordance with one feature, the integrated unit further includes a feed gas manifold within the housing to direct the feed gas flow from the feed gas inlet to the feed gas flow path, with the feed gas manifold surrounding a portion of the reformat flow outlet.

In one feature, the cylindrical wall has a uniform outer diameter extending from an inlet to the feed gas flow path to the inlet end.

As one feature, the cylindrical wall includes two cylindrical pieces that have been joined together, with one of the cylindrical pieces defining the feed gas and reformate flow paths of the recuperator heat exchanger and the other cylindrical piece surrounding the catalyst structure.

As one feature, the integrated unit further includes a glow plug extending into the housing at a location adjacent the inlet end to provide heat to the feed gas flow entering the catalyst structure.

According to one feature, the integrated unit further includes a thermowell penetrating both the housing and the cylindrical wall to extend into the interior volume at a location between the catalyst structure and the reformate flow path. As a further feature, the thermowell is fixed to the housing and allowed to float relative to the cylindrical wall. As yet a further feature, the cylindrical wall includes a clearance hole through which the thermowell extends, and further including a disc mounted on the thermal well covering the clearance hole to restrict the flow of gas through the clearance hole.

In one feature, the integrated unit includes a structural connection between the cylindrical wall and the housing at an end of the cylindrical wall opposite from the inlet end, and wherein the inlet end is free to expand longitudinally relative to the housing.

In accordance with one feature of the invention, the integrated unit includes a cylindrical housing including a feed gas inlet and a reformate flow outlet located adjacent a first end of the cylindrical housing; an autothermal reformer catalyst structure located in the housing and spaced from the first end; a recuperator heat exchanger located in the housing between the first end and the catalyst structure; a feed gas flow path in the housing extending from the feed gas inlet, through the recuperator heat exchanger, and to the catalyst structure; and a reformate flow path in the housing extending from the catalyst structure, through the recuperator heat exchanger, and to the reformate outlet. The reformate flow path is in heat exchange relation with the feed gas flow path in the recuperator heat exchanger.

As one feature, the feed gas and reformate flow paths are defined by a cylindrical wall located in the housing, and the autothermal reformer catalyst structure is contained in an interior volume surrounded by the cylindrical wall.

According to one feature, the reformate flow path extending through the recuperator heat exchanger is defined between the cylindrical wall and a second cylindrical wall contained within the interior volume.

In one feature, the integrated unit further includes a glow plug extending into the housing at a location adjacent the catalyst structure to provide heat to the feed gas flow entering the catalyst structure.

As one feature, the integrated unit includes a structural connection between an end of the cylindrical wall and the housing at the first end, and wherein an opposite end of the cylindrical wall is free to expand longitudinally relative to the housing.

Other objects, features, and advantages of the invention will become apparent from a review of the entire specification, including the appended claims and drawings.

### BRIEF DESCRIPTION OF THE DRAWINGS

FIG. 1 is a sectioned, perspective view of an integrated ATR/recuperator embodying the present invention;

FIG. 2 is a sectioned, perspective view showing another integrated ATR/recuperator assembly embodying the present invention;

FIG. 3 is an exploded view of FIG. 2; and

FIG. 4 is an enlarged view taken from line 4-4 in FIG. 1.

### DETAILED DESCRIPTION OF THE PREFERRED EMBODIMENTS

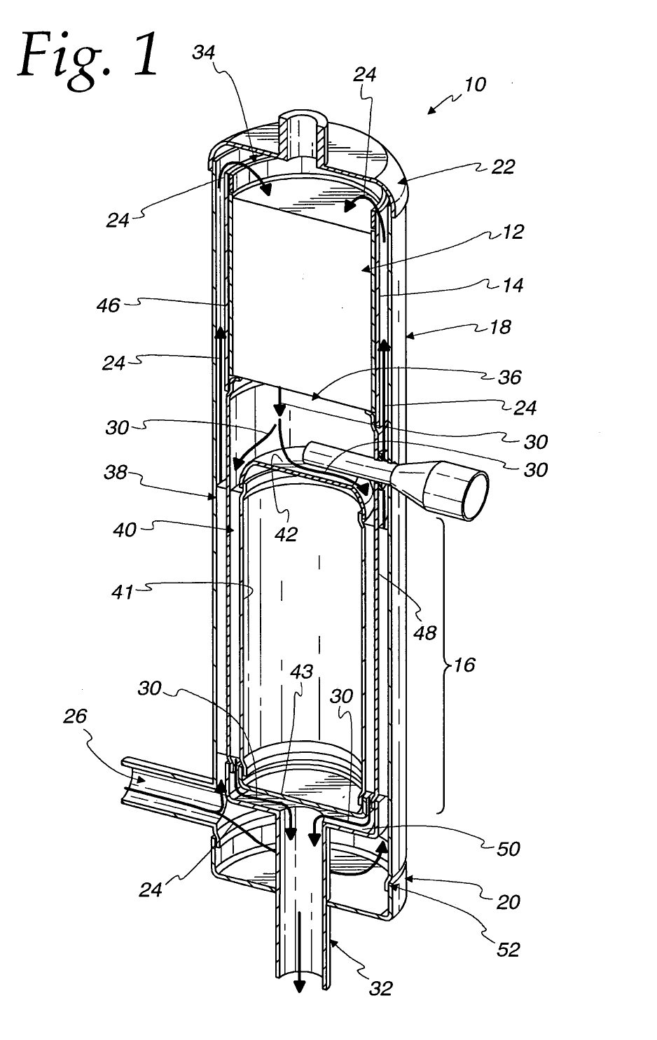

An integrated ATR/recuperator unit 10 is shown in FIG. 1 and includes an ATR (autothermal reformer) catalyst structure in the form of a catalyst monolith 12, surrounded by a cylindrical wall 14, and a recuperator heat exchanger 16 with both the recuperator 16 and the ATR monolith 12 contained within a cylindrical housing 18. The housing 18 includes a first end 20 and a second end 22, with the catalyst structure 12 located adjacent the second end 22, and the recuperator heat exchanger 16 located between the first end 20 and the catalyst structure 12. The integrated unit 10 further includes a feed gas flow path, shown by the arrows 24, in the housing 18 extending from a feed gas inlet 26 through the recuperator 16 and to the catalyst structure 12; and a reformate flow path, shown by the arrows 30, in the housing 18 extending from the catalyst structure 12 through the recuperator 16 and to a reformate outlet 32, with the reformate flow path 30 being in heat exchange relation with the feed gas flow path 24 in the recuperator 16.

The cylindrical wall 14 has an inlet end 34 to receive the feed gas flow into an interior volume 36 that is surrounded by the cylindrical wall 14. The catalyst structure 12 is contained in the interior volume 36 to receive the feed gas flow and deliver a reformate flow to the remainder of the interior volume 36. Preferably, when the structure 12 is in the form of a monolith, as illustrated, the monolith is wrapped in an intumescent mat 37 and secured with flanges at its ends. Any suitable autothermal reforming catalyst may be used for the catalyst structure 12. Similarly, while the catalyst structure 12 has been shown in the form of a monolith, other catalyst structures may be desirable for certain applications.

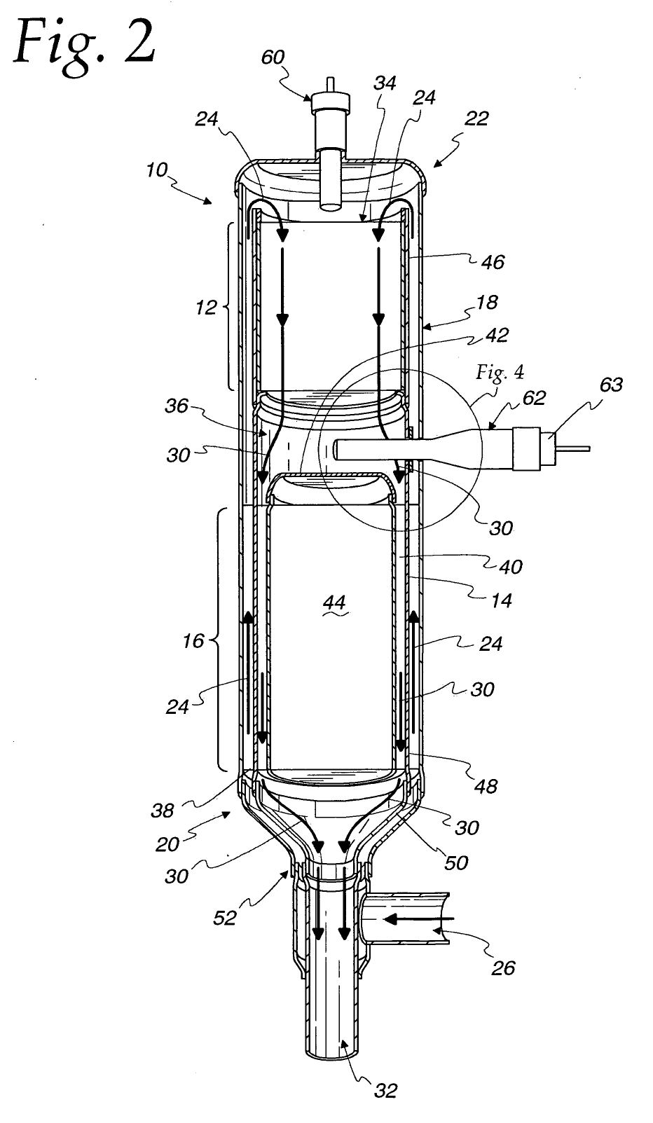

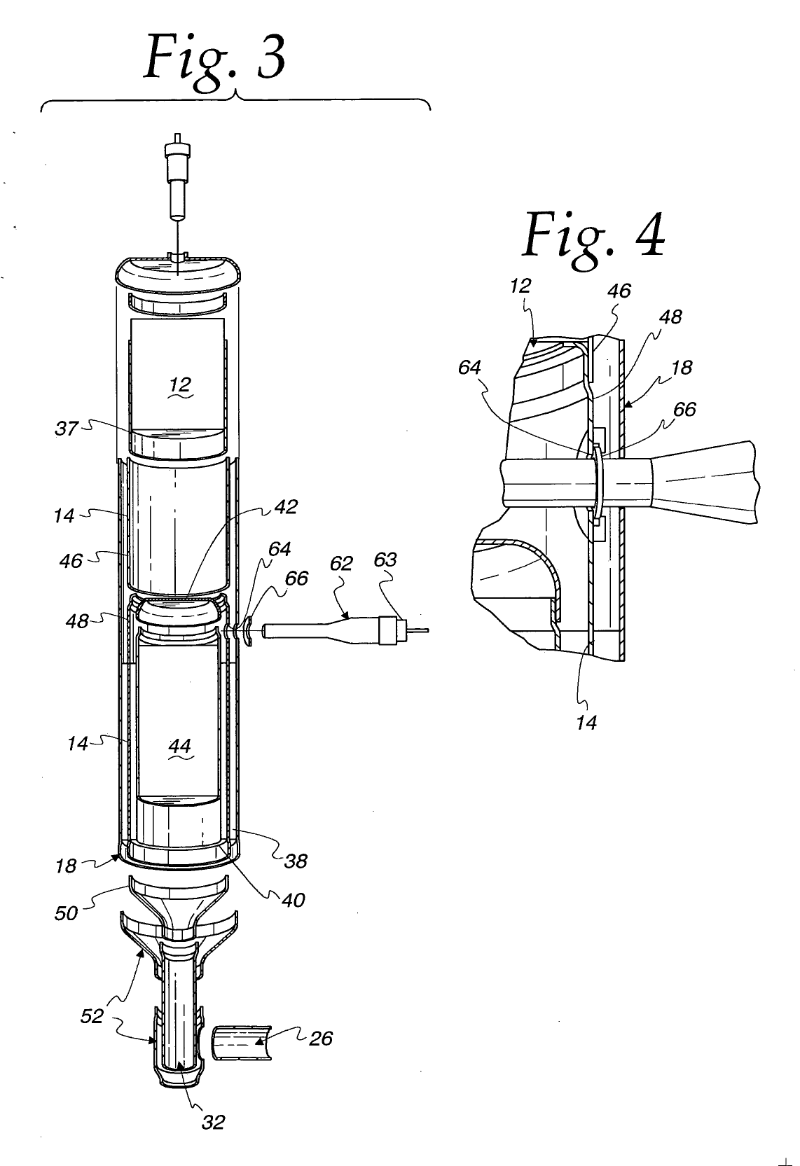

The recuperator 16 includes the cylindrical wall 14 which separates the feed gas flow path 24 from the reformate flow path 32 in the recuperator 16. Preferably, serpentine fins 38 and 40 or other suitable thermal and/or flow enhancements are included in the feed gas flow path 24 and the reformate flow path 32, respectively, and are in heat transfer contact, and preferably bonded, with the cylindrical wall 14 to improve the transfer of heat from the reformate flow to the feed gas flow. In this regard, it is also preferred that the fin 38 in the feed gas flow path 24 not be bonded to the cylindrical housing 18, which allows for differential thermal expansion between the fin 38 and the housing 18. The recuperator 16 also preferably includes an inner cylindrical wall 41 that cooperates with the wall 14 to define the reformate flow path 32 through the recuperator 16. The feed gas flow path 24 through the recuperator 16 is defined between the wall 14 and the cylindrical housing 18 of the unit 10. A dome-shaped baffle 42 is preferably provided at the inlet side of the inner cylindrical wall 41 in order to direct the reformate flow into the reformate flow path 32 through the recuperator 16. It is preferred that an end cap 43 (shown in FIG. 1) or an insulation block 44 (shown in FIGS. 2 and 3) be provided to close or fill the interior volume of the inner cylindrical wall 41 so as to minimize the internal combustible volume of the integrated unit 10.

Preferably, the portion 46 of the cylindrical wall 14 surrounding the catalyst structure 12 is formed from a separate piece of material that is joined to another portion 48 of the cylindrical wall 18 that extends through the recuperator 16. This construction allows for the ease of manufacture of both the recuperator 16 and the catalyst structure 12.

An end baffle 50 is connected to the cylindrical wall 14 at an end of the cylindrical wall 14 opposite from the inlet end 34 to direct the reformate flow to the reformate flow outlet 32. A feed gas manifold structure 52 surrounds a portion of the reformate flow outlet 32 and directs the feed gas flow from the feed gas inlet 26 to the feed gas flow path 24 through the recuperator 16. Together the end baffle 50 and the feed gas manifold structure 52 cooperate with the reformate flow outlet 32 to provide a structural connection between the cylindrical wall 14 and the housing 18 at the end 20. The inlet end 34 of the cylindrical wall 14 has no direct connection to the housing 18 thereby allowing the inlet end 34 to expand freely in the longitudinal direction relative to the housing 18 to accommodate differences in thermal growth between the structures.

Preferably, the integrated ATR/recuperator also includes a glow plug 60 be located adjacent the inlet of the catalyst structure 12, and a thermowell 62 located between an outlet end of the ATR monolith and the inlet side of the reformate flow path through the recuperator to accommodate a temperature probe 63 for monitoring the exit temperature of the reformate from the catalyst structure 12 and to generate a signal representative of the temperature for monitoring and/or control purposes of the fuel reforming cycle. In some systems, the glow plug 60 may be desirable to increase the temperature of the feed gas during startup conditions. While the thermowell 62 is shown as being located between the exit of the catalyst structure 12 and the entrance to the reformate flow path 30 in the recuperator 16, it is possible for the temperature of the feed gas and/or reformate to be monitored at other locations and used for control in some systems. Accordingly, it may desirable to locate the thermowell 62 in other positions within the integrated ATR/recuperator unit 10.

Preferably, the thermowell 62 penetrates both the housing 18 and the cylindrical wall 14 to extend into the interior volume 36, with the cylindrical wall 18 having a clearance hole 64 through which the thermowell 62 extends, and a disk 66 mounted on the thermowell covering the clearance hole 64 to restrict the cross flow of gas through the clearance hole 64. This allows for differences in thermal expansion between the housing 18 and the cylindrical wall 14 without stressing the thermowell 62, the cylindrical wall 14, or the housing 18.

While any orientation is possible, in some applications it is preferred that the integrated unit 10 be oriented vertically, as shown in FIG. 1, with the end 20 at the bottom and the end 22 at the top. Furthermore, while the particular materials selected for the integrated unit 10 will depend highly on the particular application, one suitable material is a type 310S stainless steel (UNS31008), with the components being joined by a suitable braze alloy, such as AWS BNi-5.

1. An integrated autothermal reformer/recuperator unit for use in reforming a feed gas flow to produce a reformate flow, the unit comprising:
a housing including a feed gas inlet and a reformate flow outlet;
a cylindrical wall located in said housing, the cylindrical wall having an inlet end to receive the feed gas flow into an interior volume surrounded by the cylindrical wall, the cylindrical wall positioned relative to the feed gas inlet and outlet to direct the feed gas flow from the feed gas inlet to the inlet end and to direct the reformate flow from the interior volume to the reformate flow outlet;
an autothermal reformer catalyst structure contained in said interior volume to receive the feed gas flow and deliver a reformate flow to the interior volume; and
a recuperator heat exchanger comprising a feed gas flow path in heat exchange relation with a reformate flow path; the feed gas flow path defined between the housing and the cylindrical wall at a location upstream from the inlet end with respect to the feed gas flow, and the reformate flow path located within the interior volume downstream from the catalyst structure with respect to the reformate flow.

2. The integrated unit of claims 1 wherein the reformate flow path is defined between the cylindrical wall and a second cylindrical wall contained within the interior volume.

3. The integrated unit of claim 2 further comprising a baffle located between the catalyst structure and the reformate flow path to direct the reformate flow into the reformate flow path.

4. The integrated unit of claim 2 wherein the catalyst structure comprises a catalyst monolith.

5. The integrated unit of claim 1 further comprising an end baffle connected to the cylindrical wall at an end of the cylindrical wall opposite from the inlet end to direct the reformate flow from the reformate flow path to the reformate flow outlet.

6. The integrated unit of claim 1 further comprising a feed gas manifold in the housing to direct the feed gas flow from the feed gas inlet to the feed gas flow path; the feed gas manifold surrounding a portion of the reformat flow outlet.

7. The integrated unit of claim 1 wherein said cylindrical wall has a uniform outer diameter extending from an inlet to the feed gas flow path to the inlet end.

8. The integrated unit of claim 1 wherein said cylindrical wall comprises two cylindrical pieces that have been joined together, with one of the cylindrical pieces defining the feed gas and reformate flow paths of the recuperator heat exchanger and the other cylindrical piece surrounding the catalyst structure.

9. The integrated unit of claim 1 further comprising a glow plug extending into the housing at a location adjacent the inlet end to provide heat to the feed gas flow entering the catalyst structure.

10. The integrated unit of claim 1 further comprising a thermowell penetrating both the housing and the cylindrical wall to extend into the interior volume at a location between the catalyst structure and the reformate flow path.

11. The integrated unit of claim 10 wherein the thermowell is fixed to the housing and allowed to float relative to the cylindrical wall.

12. The integrated unit of claim 11 wherein the cylindrical wall comprises a clearance hole through which the thermowell extends, and further comprising a disc mounted on the thermal well covering the clearance hole to restrict the flow of gas through the clearance hole.

13. The integrated unit of claim 1 comprising a structural connection between the cylindrical wall and the housing at an end of the cylindrical wall opposite from the inlet end, and wherein the inlet end is free to expand longitudinally relative to the housing.

14. An integrated autothermal reformer/recuperator unit for use in reforming a feed gas flow to produce a reformate flow, the unit comprising:
a cylindrical housing including a feed gas inlet and a reformate flow outlet located adjacent a first end of the cylindrical housing;
an autothermal reformer catalyst structure located in the housing and spaced from the first end;
a recuperator heat exchanger located in the housing between the first end and the catalyst structure;
a feed gas flow path in said housing extending from the feed gas inlet, through the recuperator heat exchanger, and to the catalyst structure; and
a reformate flow path in said housing extending from the catalyst structure, through the recuperator heat exchanger, and to the reformate outlet, the reformate flow path in heat exchange relation with the feed gas flow path in the recuperator heat exchanger.

15. The integrated unit of claim 14 wherein the feed gas and reformate flow paths are defined by a cylindrical wall located in said housing, the autothermal reformer catalyst structure contained in an interior volume surrounded by the cylindrical wall.

16. The integrated unit of claims 15 wherein the reformate flow path extending through the recuperator heat exchanger is defined between the cylindrical wall and a second cylindrical wall contained within the interior volume.

17. The integrated unit of claim 14 further comprising a baffle located between the catalyst structure and the recuperator heat exchanger to direct the reformate flow into the recuperator heat exchanger.

18. The integrated unit of claim 14 wherein the catalyst structure comprises a catalyst monolith.

19. The integrated unit of claim 15 wherein said cylindrical wall has a uniform outer diameter extending from an inlet to the feed gas flow path to the inlet end.

20. The integrated unit of claim 19 wherein said cylindrical wall comprises two cylindrical pieces that have been joined together, with one of the cylindrical pieces defining the feed gas and reformate flow paths of the recuperator and the other cylindrical piece surrounding the catalyst structure.

21. The integrated unit of claim 14 further comprising a glow plug extending into the housing at a location adjacent the catalyst structure to provide heat to the feed gas flow entering the catalyst structure.

22. The integrated unit of claim 15 further comprising a thermowell penetrating both the housing and the cylindrical wall to extend into the interior volume at a location between the catalyst structure and the recuperator heat exchanger.

23. The integrated unit of claim 22 wherein the thermowell is fixed to the housing and allowed to float relative to the cylindrical wall.

24. The integrated unit of claim 23 wherein the cylindrical wall comprises a clearance hole through which the thermowell extends, and further comprising a disc mounted on the thermal well covering the clearance hole to restrict the flow of gas through the clearance hole.

25. The integrated unit of claim 15 comprising a structural connection between and end of the cylindrical wall and the housing at the first end, and wherein an opposite end of the cylindrical wall is free to expand longitudinally relative to the housing.
